(19) United States
(12) Patent Application Publication
(10) Pub. No.: US 2014/0012534 A1
(43) Pub. Date: Jan. 9, 2014

(54) NON-DESTRUCTIVE METHOD TO DETERMINE CRYSTALLINITY IN AMORPHOUS ALLOY USING SPECIFIC HEAT CAPACITY

(71) Applicants: Christopher D. PREST, San Francisco, CA (US); Matthew S. SCOTT, Campbell, CA (US); Dermot J. STRATTON, San Francisco, CA (US); Joseph C. POOLE, San Francisco, CA (US); Theodore A. WANIUK, Lake Forest, CA (US)

(72) Inventors: Christopher D. PREST, San Francisco, CA (US); Matthew S. SCOTT, Campbell, CA (US); Dermot J. STRATTON, San Francisco, CA (US); Joseph C. POOLE, San Francisco, CA (US); Theodore A. WANIUK, Lake Forest, CA (US)

(21) Appl. No.: 13/541,694

(22) Filed: Jul. 4, 2012

(51) Int. Cl. G01K 17/00; G06F 15/00

(52) U.S. Cl. 702/136; 374/31; 374/E17.001

(57) ABSTRACT

One embodiment provides a method and apparatus for determining an unknown degree of crystallinity of a bulk-solidifying amorphous alloy specimen based on the heat capacity of the specimen. The method and apparatus make use of the different heat capacities of alloys having differing degrees of crystallinity.

All publications, patents, and patent applications cited in this Specification are hereby incorporated by reference in their entirety.

### BACKGROUND

A large portion of the metallic alloys in use today are processed by solidification casting, at least initially. The metallic alloy is melted and cast into a metal or ceramic mold, where it solidifies. The mold is stripped away, and the cast metallic piece is ready for use or further processing. The as-cast structure of most materials produced during solidification and cooling depends upon the cooling rate. There is no general rule for the nature of the variation, but for the most part the structure changes only gradually with changes in cooling rate. On the other hand, for the bulk-solidifying amorphous alloys the change between the amorphous state produced by relatively rapid cooling and the crystalline state produced by relatively slower cooling is one of kind rather than degree—the two states have distinct properties.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. This amorphous state can be highly advantageous for certain applications. If the cooling rate is not sufficiently high, crystals may form inside the alloy during cooling, so that the benefits of the amorphous state are lost. For example, one risk with the creation of bulk amorphous alloy parts is partial crystallization due to either slow cooling or impurities in the raw material. Thus, ensuring a high degree of amorphicity (and, conversely, a low degree of crystallinity) can be important in the quality control of a BMG fabrication process.

In other embodiments, some crystallization is desirable. In these embodiments, an already prepared amorphous alloy material may be thermally annealed to induce partial crystallization. Depending on the particular end use of the bulk-solidifying amorphous alloy, some crystallization may be desirable, or little or no crystallization may be desired. In either case, it is advantageous to know the degree of crystallization, or crystallinity (or 1−amorphicity) of the material.

Currently, methods used to measure the degree of crystallinity include the bending test, x-ray radiography, and etching. These techniques are destructive, however, to the measurement specimens. The most common method for screening relies on either a destructive strength test, or sectioning and subsequent visual screening for crystallization. As a result, for a BMG part (e.g., a casing) that needs to be measured for its degree of crystallinity, it needs to first be significantly altered (e.g., sectioned, published, and/or ground to a powder form).

Thus, a need exists to develop methods that can provide a measurement of the degree of crystallinity of a BMG non-destructively, thereby facilitating quality control of its fabrication process.

### SUMMARY

One embodiment provides a method of determining an unknown degree of crystallinity, the method including first obtaining a master curve representing a relationship between heat capacity and crystallinity for a bulk-solidifying amorphous alloy of a given chemical composition. The method also includes providing an alloy specimen having the given chemical composition and an unknown degree of crystallinity, and measuring the heat capacity of the specimen. The method concludes by determining the unknown degree of crystallinity by comparing the calculated heat capacity to the master curve.

An alternative embodiment provides a method of determining an unknown degree of crystallinity, the method including first obtaining a master curve representing a respective relationship between heat capacity and crystallinity for a bulk-solidifying amorphous alloy of a given chemical composition. The method also includes providing an alloy specimen having the given chemical composition and an unknown degree of crystallinity, and measuring the heat capacity of the specimen by heating the specimen, and then allowing the specimen to cool while continuously changing the environmental temperature, and taking an average of the heat capacity over a range of environmental temperatures. The method concludes by deteimining the unknown degree of crystallinity by comparing the heat capacity to the master curve.

Another embodiment provides a method of determining an unknown degree of crystallinity that includes first measuring the heat capacity of a bulk-solidifying amorphous alloy of a given chemical composition in its purely amorphous state and its purely crystalline state. The method also includes providing an alloy specimen having the given chemical composition and an unknown degree of crystallinity, and measuring the heat capacity of the specimen. The method concludes by determining the unknown degree of crystallinity by subtracting the heat capacity of the alloy specimen from the heat capacity of the purely amorphous alloy, and dividing that value by the difference between the heat capacities of the purely amorphous alloy and the purely crystalline alloy.

Another embodiment is an apparatus for non-destructively measuring the crystallinity in a bulk-solidifying amorphous alloy sample. The apparatus includes a measurement sector that includes a mechanism for applying heat to a sample, a device for placing the specimen in a controlled environment, a mechanism for maintaining or changing the environmental temperature of the environment, and a mechanism for measuring the surface temperature of the specimen over time and the surface temperature of the environment over time. The apparatus also includes a calculation sector in communication with the measurement sector, the calculation sector containing at least a storage device for storing and calculating the relationship between crystallinity and heat capacity for a given bulk-solidifying amorphous alloy, a mechanism to calculate the heat capacity of the sample based at least on the measured temperatures of the specimen and environment, and a mechanism to calculate the degree of crystallinity of the sample based on the calculated heat capacity.

### BRIEF DESCRIPTION OF THE DRAWINGS

FIG. 1 provides a temperature-viscosity diagram of an exemplary bulk solidifying amorphous alloy.

FIG. 2 provides a schematic of a time-temperature-transformation (TTT) diagram for an exemplary bulk solidifying amorphous alloy.

FIG. 3 is a curve showing the relationship between heat capacity and temperature for an amorphous material and a crystalline material.

FIG. 4 is a curve showing the relationship between heat capacity and temperature and its leveling off at about 3R at the Debye temperature θ_{D}.

FIG. 5 is a curve showing the relationship between heat capacity and temperature at low temperatures (below the Debye temperature) for a fully amorphous and a fully crystalline bulk-solidifying amorphous alloy.

FIG. 6 is an exemplary master curve showing the relationship between heat capacity and crystallinity for a bulk-solidifying amorphous alloy.

FIG. 7 is a schematic of an apparatus useful in determining the heat capacity of a specimen.

### DETAILED DESCRIPTION

All publications, patents, and patent applications cited in this Specification are hereby incorporated by reference in their entirety.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

Bulk-solidifying amorphous alloys, or bulk metallic glasses (“BMG”), are a recently developed class of metallic materials. These alloys may be solidified and cooled at relatively slow rates, and they retain the amorphous, non-crystalline (i.e., glassy) state at room temperature. Amorphous alloys have many superior properties than their crystalline counterparts. However, if the cooling rate is not sufficiently high, crystals may form inside the alloy during cooling, so that the benefits of the amorphous state can be lost. For example, one challenge with the fabrication of bulk amorphous alloy parts is partial crystallization of the parts due to either slow cooling or impurities in the raw alloy material. As a high degree of amorphicity (and, conversely, a low degree of crystallinity) is desirable in BMG parts, there is a need to develop methods for casting BMG parts having controlled amount of amorphicity.

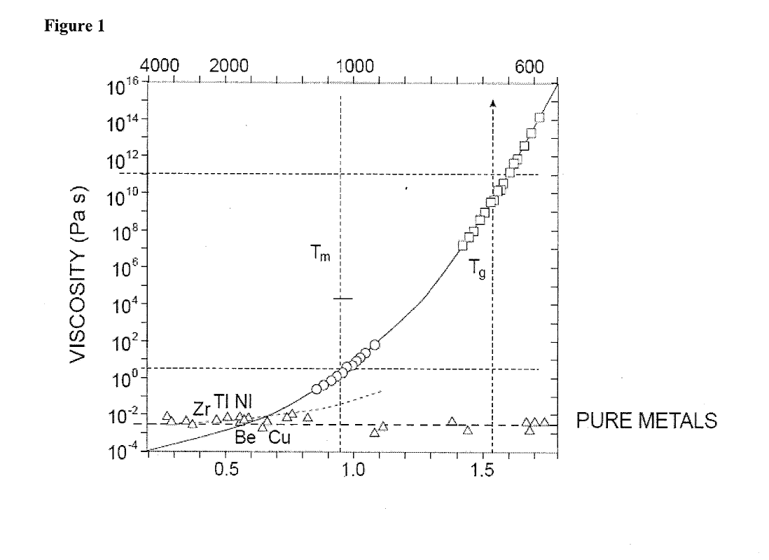

FIG. 1 (obtained from U.S. Pat. No. 7,575,040) shows a viscosity-temperature graph of an exemplary bulk solidifying amorphous alloy, from the VIT-001 series of Zr—Ti—Ni—Cu—Be family manufactured by Liquidmetal Technology. It should be noted that there is no clear liquid/solid transformation for a bulk solidifying amorphous metal during the formation of an amorphous solid. The molten alloy becomes more and more viscous with increasing undercooling until it approaches solid form around the glass transition temperature. Accordingly, the temperature of solidification front for bulk solidifying amorphous alloys can be around glass transition temperature, where the alloy will practically act as a solid for the purposes of pulling out the quenched amorphous sheet product.

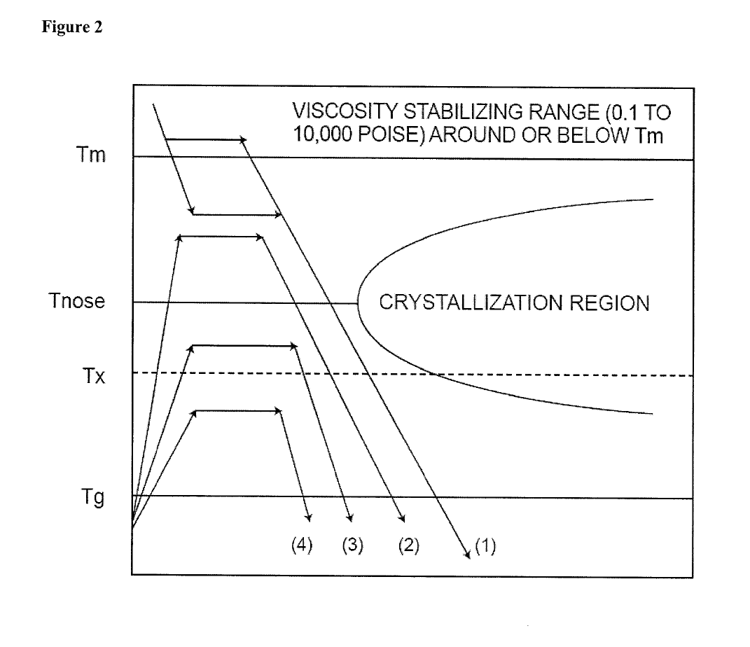

FIG. 2 (obtained from U.S. Pat. No. 7,575,040) shows the time-temperature-transformation (TTT) cooling curve of an exemplary bulk solidifying amorphous alloy, or TTT diagram. Bulk-solidifying amorphous metals do not experience a liquid/solid crystallization transformation upon cooling, as with conventional metals. Instead, the highly fluid, non crystalline form of the metal found at high temperatures (near a “melting temperature” Tm) becomes more viscous as the temperature is reduced (near to the glass transition temperature Tg), eventually taking on the outward physical properties of a conventional solid.

Even though there is no liquid/crystallization transformation for a bulk solidifying amorphous metal, a “melting temperature” Tm may be defined as the thermodynamic liquidus temperature of the corresponding crystalline phase. Under this regime, the viscosity of bulk-solidifying amorphous alloys at the melting temperature could lie in the range of about 0.1 poise to about 10,000 poise, and even sometimes under 0.01 poise. A lower viscosity at the “melting temperature” would provide faster and complete filling of intricate portions of the shell/mold with a bulk solidifying amorphous metal for forming the BMG parts. Furthermore, the cooling rate of the molten metal to form a BMG part has to such that the time-temperature profile during cooling does not traverse through the nose-shaped region bounding the crystallized region in the TTT diagram of FIG. 2. In FIG. 2, Tnose is the critical crystallization temperature Tx where crystallization is most rapid and occurs in the shortest time scale.

The supercooled liquid region, the temperature region between Tg and Tx is a manifestation of the extraordinary stability against crystallization of bulk solidification alloys. In this temperature region the bulk solidifying alloy can exist as a high viscous liquid. The viscosity of the bulk solidifying alloy in the supercooled liquid region can vary between 1012 Pa s at the glass transition temperature down to 105 Pa s at the crystallization temperature, the high temperature limit of the supercooled liquid region. Liquids with such viscosities can undergo substantial plastic strain under an applied pressure. The embodiments herein make use of the large plastic formability in the supercooled liquid region as a forming and separating method.

One needs to clarify something about Tx. Technically, the nose-shaped curve shown in the TTT diagram describes Tx as a function of temperature and time. Thus, regardless of the trajectory that one takes while heating or cooling a metal alloy, when one hits the TTT curve, one has reached Tx. In FIG. 2, Tx is shown as a dashed line as Tx can vary from close to Tm to close to Tg.

The schematic TTT diagram of FIG. 2 shows processing methods of die casting from at or above Tm to below Tg without the time-temperature trajectory (shown as (1) as an example trajectory) hitting the TTT curve. During die casting, the forming takes place substeantially simultaneously with fast cooling to avoid the trajectory hitting the TTT curve. The procssing methods for superplastic forming (SPF) from at or below Tg to below Tm without the time-temperature trajectory (shown as (2), (3) and (4) as example trajectories) hitting the TTT curve. In SPF, the amorphous BMG is reheated into the supercooled liquid region where the available processing window could be much larger than die casting, resulting in better controllability of the process. The SPF process does not require fast cooling to avoid crystallization during cooling. Also, as shown by example trajectories (2), (3) and (4), the SPF can be carried out with the highest temperature during SPF being above Tnose or below Tnose, up to about Tm. If one heats up a piece of amorphous alloy but manages to avoid hitting the TTT curve, you have heated “between Tg and Tm”, but one would have not reached Tx.

Typical differential scanning calorimeter (DSC) heating curves of bulk-solidifying amorphous alloys taken at a heating rate of 20 C/min describe, for the most part, a particular trajectory across the TTT data where one would likely see a Tg at a certain temperature, a Tx when the DSC heating ramp crosses the TTT crystallization onset, and eventually melting peaks when the same trajectory crosses the temperature range for melting. If one heats a bulk-solidifying amorphous alloy at a rapid heating rate as shown by the ramp up portion of trajectories (2), (3) and (4) in FIG. 2, then one could avoid the TTT curve entirely, and the DSC data would show a glass transition but no Tx upon heating. Another way to think about it is trajectories (2), (3) and (4) can fall anywhere in temperature between the nose of the TTT curve (and even above it) and the Tg line, as long as it does not hit the crystallization curve. That just means that the horizontal plateau in trajectories might get much shorter as one increases the processing temperature.

### Phase

The term “phase” herein can refer to one that can be found in a thermodynamic phase diagram. A phase is a region of space (e.g., a thermodynamic system) throughout which all physical properties of a material are essentially uniform. Examples of physical properties include density, index of refraction, chemical composition and lattice periodicity. A simple description of a phase is a region of material that is chemically uniform, physically distinct, and/or mechanically separable. For example, in a system consisting of ice and water in a glass jar, the ice cubes are one phase, the water is a second phase, and the humid air over the water is a third phase. The glass of the jar is another separate phase. A phase can refer to a solid solution, which can be a binary, tertiary, quaternary, or more, solution, or a compound, such as an intermetallic compound. As another example, an amorphous phase is distinct from a crystalline phase.

### Metal, Transition Metal, and Non-Metal

The term “metal” refers to an electropositive chemical element. The term “element” in this Specification refers generally to an element that can be found in a Periodic Table. Physically, a metal atom in the ground state contains a partially filled band with an empty state close to an occupied state. The term “transition metal” is any of the metallic elements within Groups 3 to 12 in the Periodic Table that have an incomplete inner electron shell and that serve as transitional links between the most and the least electropositive in a series of elements. Transition metals are characterized by multiple valences, colored compounds, and the ability to form stable complex ions. The term “nonmetal” refers to a chemical element that does not have the capacity to lose electrons and form a positive ion.

Depending on the application, any suitable nonmetal elements, or their combinations, can be used. The alloy (or “alloy composition”) can comprise multiple nonmetal elements, such as at least two, at least three, at least four, or more, nonmetal elements. A nonmetal element can be any element that is found in Groups 13-17 in the Periodic Table. For example, a nonmetal element can be any one of F, Cl, Br, I, At, O, S, Se, Te, Po, N, P, As, Sb, Bi, C, Si, Ge, Sn, Pb, and B. Occasionally, a nonmetal element can also refer to certain metalloids (e.g., B, Si, Ge, As, Sb, Te, and Po) in Groups 13-17. In one embodiment, the nonmetal elements can include B, Si, C, P, or combinations thereof. Accordingly, for example, the alloy can comprise a boride, a carbide, or both.

A transition metal element can be any of scandium, titanium, vanadium, chromium, manganese, iron, cobalt, nickel, copper, zinc, yttrium, zirconium, niobium, molybdenum, technetium, ruthenium, rhodium, palladium, silver, cadmium, hafnium, tantalum, tungsten, rhenium, osmium, iridium, platinum, gold, mercury, rutherfordium, dubnium, seaborgium, bohrium, hassium, meitnerium, ununnilium, unununium, and ununbium. In one embodiment, a BMG containing a transition metal element can have at least one of Sc, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, and Hg. Depending on the application, any suitable transitional metal elements, or their combinations, can be used. The alloy composition can comprise multiple transitional metal elements, such as at least two, at least three, at least four, or more, transitional metal elements.

The presently described alloy or alloy “sample” or “specimen” alloy can have any shape or size. For example, the alloy can have a shape of a particulate, which can have a shape such as spherical, ellipsoid, wire-like, rod-like, sheet-like, flake-like, or an irregular shape. The particulate can have any size. For example, it can have an average diameter of between about 1 micron and about 100 microns, such as between about 5 microns and about 80 microns, such as between about 10 microns and about 60 microns, such as between about 15 microns and about 50 microns, such as between about 15 microns and about 45 microns, such as between about 20 microns and about 40 microns, such as between about 25 microns and about 35 microns. For example, in one embodiment, the average diameter of the particulate is between about 25 microns and about 44 microns. In some embodiments, smaller particulates, such as those in the nanometer range, or larger particulates, such as those bigger than 100 microns, can be used.

The alloy sample or specimen can also be of a much larger dimension. For example, it can be a bulk structural component, such as an ingot, housing/casing of an electronic device or even a portion of a structural component that has dimensions in the millimeter, centimeter, or meter range.

### Solid Solution

The term “solid solution” refers to a solid form of a solution. The term “solution” refers to a mixture of two or more substances, which may be solids, liquids, gases, or a combination of these. The mixture can be homogeneous or heterogeneous. The term “mixture” is a composition of two or more substances that are combined with each other and are generally capable of being separated. Generally, the two or more substances are not chemically combined with each other.

### Alloy

In some embodiments, the alloy composition described herein can be fully alloyed. In one embodiment, an “alloy” refers to a homogeneous mixture or solid solution of two or more metals, the atoms of one replacing or occupying interstitial positions between the atoms of the other; for example, brass is an alloy of zinc and copper. An alloy, in contrast to a composite, can refer to a partial or complete solid solution of one or more elements in a metal matrix, such as one or more compounds in a metallic matrix. The term alloy herein can refer to both a complete solid solution alloy that can give single solid phase microstructure and a partial solution that can give two or more phases. An alloy composition described herein can refer to one comprising an alloy or one comprising an alloy-containing composite.

Thus, a fully alloyed alloy can have a homogenous distribution of the constituents, be it a solid solution phase, a compound phase, or both. The term “fully alloyed” used herein can account for minor variations within the error tolerance. For example, it can refer to at least 90% alloyed, such as at least 95% alloyed, such as at least 99% alloyed, such as at least 99.5% alloyed, such as at least 99.9% alloyed. The percentage herein can refer to either volume percent or weight percentage, depending on the context. These percentages can be balanced by impurities, which can be in terms of composition or phases that are not a part of the alloy.

### Amorphous or Non-Crystalline Solid

An “amorphous” or “non-crystalline solid” is a solid that lacks lattice periodicity, which is characteristic of a crystal. As used herein, an “amorphous solid” includes “glass” which is an amorphous solid that softens and transforms into a liquid-like state upon heating through the glass transition. Generally, amorphous materials lack the long-range order characteristic of a crystal, though they can possess some short-range order at the atomic length scale due to the nature of chemical bonding. The distinction between amorphous solids and crystalline solids can be made based on lattice periodicity as determined by structural characterization techniques such as x-ray diffraction and transmission electron microscopy.

The terms “order” and “disorder” designate the presence or absence of some symmetry or correlation in a many-particle system. The terms “long-range order” and “short-range order” distinguish order in materials based on length scales.

The strictest form of order in a solid is lattice periodicity: a certain pattern (the arrangement of atoms in a unit cell) is repeated again and again to form a translationally invariant tiling of space. This is the defining property of a crystal. Possible symmetries have been classified in 14 Bravais lattices and 230 space groups.

Lattice periodicity implies long-range order. If only one unit cell is known, then by virtue of the translational symmetry it is possible to accurately predict all atomic positions at arbitrary distances. The converse is generally true, except, for example, in quasi-crystals that have perfectly deterministic tilings but do not possess lattice periodicity.

Long-range order characterizes physical systems in which remote portions of the same sample exhibit correlated behavior. This can be expressed as a correlation function, namely the spin-spin correlation function:

In the above function, s is the spin quantum number and x is the distance function within the particular system. This function is equal to unity when x=x′ and decreases as the distance |x−x′| increases. Typically, it decays exponentially to zero at large distances, and the system is considered to be disordered. If, however, the correlation function decays to a constant value at large |x−x′|, then the system can be said to possess long-range order. If it decays to zero as a power of the distance, then it can be called quasi-long-range order. Note that what constitutes a large value of |x−x′| is relative.

A system can be said to present quenched disorder when some parameters defining its behavior are random variables that do not evolve with time (i.e., they are quenched or frozen)—e.g., spin glasses. It is opposite to annealed disorder, where the random variables are allowed to evolve themselves. Embodiments herein include systems comprising quenched disorder.

The alloy described herein can be crystalline, partially crystalline, amorphous, or substantially amorphous. For example, the alloy sample/specimen can include at least some crystallinity, with grains/crystals having sizes in the nanometer and/or micrometer ranges. Alternatively, the alloy can be substantially amorphous, such as fully amorphous. In one embodiment, the alloy composition is at least substantially not amorphous, such as being substantially crystalline, such as being entirely crystalline.

In one embodiment, the presence of a crystal or a plurality of crystals in an otherwise amorphous alloy can be construed as a “crystalline phase” therein. The degree of crystallinity (or “crystallinity” for short in some embodiments) of an alloy can refer to the amount of the crystalline phase present in the alloy. The degree can refer to, for example, a fraction of crystals present in the alloy. The fraction can refer to volume fraction or weight fraction, depending on the context. A measure of how “amorphous” an amorphous alloy is can be amorphicity. Amorphicity can be measured in terms of a degree of crystallinity. For example, in one embodiment, an alloy having a low degree of crystallinity can be said to have a high degree of amorphicity. In one embodiment, for example, an alloy having 60 vol % crystalline phase can have a 40 vol % amorphous phase.

### Amorphous Alloy or Amorphous Metal

An “amorphous alloy” is an alloy having an amorphous content of more than 50% by volume, preferably more than 90% by volume of amorphous content, more preferably more than 95% by volume of amorphous content, and most preferably more than 99% to almost 100% by volume of amorphous content. Note that, as described above, an alloy high in amorphicity is equivalently low in degree of crystallinity. An “amorphous metal” is an amorphous metal material with a disordered atomic-scale structure. In contrast to most metals, which are crystalline and therefore have a highly ordered arrangement of atoms, amorphous alloys are non-crystalline. Materials in which such a disordered structure is produced directly from the liquid state during cooling are sometimes referred to as “glasses.” Accordingly, amorphous metals are commonly referred to as “metallic glasses” or “glassy metals.” In one embodiment, a bulk metallic glass (“BMG”) can refer to an alloy, of which the microstructure is at least partially amorphous. However, there are several ways besides extremely rapid cooling to produce amorphous metals, including physical vapor deposition, solid-state reaction, ion irradiation, melt spinning, and mechanical alloying. Amorphous alloys can be a single class of materials, regardless of how they are prepared.

Amorphous metals can be produced through a variety of quick-cooling methods. For instance, amorphous metals can be produced by sputtering molten metal onto a spinning metal disk. The rapid cooling, on the order of millions of degrees a second, can be too fast for crystals to form, and the material is thus “locked in” a glassy state. Also, amorphous metals/alloys can be produced with critical cooling rates low enough to allow formation of amorphous structures in thick layers—e.g., bulk metallic glasses.

The terms “bulk metallic glass” (“BMG”), bulk amorphous alloy (“BAA”), and bulk solidifying amorphous alloy are used interchangeably herein. They refer to amorphous alloys having the smallest dimension at least in the millimeter range. For example, the dimension can be at least about 0.5 mm, such as at least about 1 mm, such as at least about 2 mm, such as at least about 4 mm, such as at least about 5 mm, such as at least about 6 mm, such as at least about 8 mm, such as at least about 10 mm, such as at least about 12 mm. Depending on the geometry, the dimension can refer to the diameter, radius, thickness, width, length, etc. A BMG can also be a metallic glass having at least one dimension in the centimeter range, such as at least about 1.0 cm, such as at least about 2.0 cm, such as at least about 5.0 cm, such as at least about 10.0 cm. In some embodiments, a BMG can have at least one dimension at least in the meter range. A BMG can take any of the shapes or forms described above, as related to a metallic glass. Accordingly, a BMG described herein in some embodiments can be different from a thin film made by a conventional deposition technique in one important aspect—the former can be of a much larger dimension than the latter.

Amorphous metals can be an alloy rather than a pure metal. The alloys may contain atoms of significantly different sizes, leading to low free volume (and therefore having viscosity up to orders of magnitude higher than other metals and alloys) in a molten state. The viscosity prevents the atoms from moving enough to form an ordered lattice. The material structure may result in low shrinkage during cooling and resistance to plastic deformation. The absence of grain boundaries, the weak spots of crystalline materials in some cases, may, for example, lead to better resistance to wear and corrosion. In one embodiment, amorphous metals, while technically glasses, may also be much tougher and less brittle than oxide glasses and ceramics.

Thermal conductivity of amorphous materials may be lower than that of their crystalline counterparts. To achieve formation of an amorphous structure even during slower cooling, the alloy may be made of three or more components, leading to complex crystal units with higher potential energy and lower probability of formation. The formation of amorphous alloy can depend on several factors: the composition of the components of the alloy; the atomic radius of the components (preferably with a significant difference of over 12% to achieve high packing density and low free volume); and the negative heat of mixing the combination of components, inhibiting crystal nucleation and prolonging the time the molten metal stays in a supercooled state. However, as the formation of an amorphous alloy is based on many different variables, it can be difficult to make a prior determination of whether an alloy composition would form an amorphous alloy.

Amorphous alloys, for example, of boron, silicon, phosphorus, and other glass formers with magnetic metals (iron, cobalt, nickel) may be magnetic, with low coercivity and high electrical resistance. The high resistance leads to low losses by eddy currents when subjected to alternating magnetic fields, a property useful, for example, as transformer magnetic cores.

Amorphous alloys may have a variety of potentially useful properties. In particular, they tend to be stronger than crystalline alloys of similar chemical composition, and they can sustain larger reversible (“elastic”) deformations than crystalline alloys. Amorphous metals derive their strength directly from their non-crystalline structure, which can have none of the defects (such as dislocations) that limit the strength of crystalline alloys. For example, one modern amorphous metal, known as Vitreloy™, has a tensile strength that is almost twice that of high-grade titanium. In some embodiments, metallic glasses at room temperature are not ductile and tend to fail suddenly when loaded in tension, which limits the material applicability in reliability-critical applications, as the impending failure is not evident. Therefore, to overcome this challenge, metal matrix composite materials having a metallic glass matrix containing dendritic particles or fibers of a ductile crystalline metal can be used. Alternatively, a BMG low in element(s) that tend to cause embitterment (e.g., Ni) can be used. For example, a Ni-free BMG can be used to improve the ductility of the BMG.

Another useful property of bulk amorphous alloys is that they can be true glasses; in other words, they can soften and flow upon heating. This can allow for easy processing, such as by injection molding, in much the same way as polymers. As a result, amorphous alloys can be used for making sports equipment, medical devices, electronic components and equipment, and thin films. Thin films of amorphous metals can be deposited as protective coatings via a high velocity oxygen fuel technique.

A material can have an amorphous phase, a crystalline phase, or both. The amorphous and crystalline phases can have the same chemical composition and differ only in the microstructure—i.e., one amorphous and the other crystalline. Microstructure in one embodiment refers to the structure of a material as revealed by a microscope at 25× magnification or higher. Alternatively, the two phases can have different chemical compositions and microstructures. For example, a composition can be partially amorphous, substantially amorphous, or completely amorphous.

As described above, the degree of amorphicity (and conversely the degree of crystallinity) can be measured by fraction of crystals present in the alloy. The degree can refer to volume fraction of weight fraction of the crystalline phase present in the alloy. A partially amorphous composition can refer to a composition of at least about 5 vol % of which is of an amorphous phase, such as at least about 10 vol %, such as at least about 20 vol %, such as at least about 40 vol %, such as at least about 60 vol %, such as at least about 80 vol %, such as at least about 90 vol %. The terms “substantially” and “about” have been defined elsewhere in this application. Accordingly, a composition that is at least substantially amorphous can refer to one of which at least about 90 vol % is amorphous, such as at least about 95 vol %, such as at least about 98 vol %, such as at least about 99 vol %, such as at least about 99.5 vol %, such as at least about 99.8 vol %, such as at least about 99.9 vol %. In one embodiment, a substantially amorphous composition can have some incidental, insignificant amount of crystalline phase present therein.

In one embodiment, an amorphous alloy composition can be homogeneous with respect to the amorphous phase. A substance that is uniform in composition is homogeneous. This is in contrast to a substance that is heterogeneous. The term “composition” refers to the chemical composition and/or microstructure in the substance. A substance is homogeneous when a volume of the substance is divided in half and both halves have substantially the same composition. For example, a particulate suspension is homogeneous when a volume of the particulate suspension is divided in half and both halves have substantially the same volume of particles. However, it might be possible to see the individual particles under a microscope. Another example of a homogeneous substance is air where different ingredients therein are equally suspended, though the particles, gases and liquids in air can be analyzed separately or separated from air.

A composition that is homogeneous with respect to an amorphous alloy can refer to one having an amorphous phase substantially uniformly distributed throughout its microstructure. In other words, the composition macroscopically comprises a substantially uniformly distributed amorphous alloy throughout the composition. In an alternative embodiment, the composition can be of a composite, having an amorphous phase having therein a non-amorphous phase. The non-amorphous phase can be a crystal or a plurality of crystals. The crystals can be in the form of particulates of any shape, such as spherical, ellipsoid, wire-like, rod-like, sheet-like, flake-like, or an irregular shape. In one embodiment, it can have a dendritic form. For example, an at least partially amorphous composite composition can have a crystalline phase in the shape of dendrites dispersed in an amorphous phase matrix; the dispersion can be uniform or non-uniform, and the amorphous phase and the crystalline phase can have the same or a different chemical composition. In one embodiment, they have substantially the same chemical composition. In another embodiment, the crystalline phase can be more ductile than the BMG phase.

The methods described herein can be applicable to any type of amorphous alloy. Similarly, the amorphous alloy described herein as a constituent of a composition or article can be of any type. The amorphous alloy can comprise the element Zr, Hf, Ti, Cu, Ni, Pt, Pd, Fe, Mg, Au, La, Ag, Al, Mo, Nb, Be, or combinations thereof. Namely, the alloy can include any combination of these elements in its chemical formula or chemical composition. The elements can be present at different weight or volume percentages. For example, an iron “based” alloy can refer to an alloy having a non-insignificant weight percentage of iron present therein, the weight percent can be, for example, at least about 20 wt %, such as at least about 40 wt %, such as at least about 50 wt %, such as at least about 60 wt %, such as at least about 80 wt %. Alternatively, in one embodiment, the above-described percentages can be volume percentages, instead of weight percentages. Accordingly, an amorphous alloy can be zirconium-based, titanium-based, platinum-based, palladium-based, gold-based, silver-based, copper-based, iron-based, nickel-based, aluminum-based, molybdenum-based, and the like. The alloy can also be free of any of the aforementioned elements to suit a particular purpose. For example, in some embodiments, the alloy, or the composition including the alloy, can be substantially free of nickel, aluminum, titanium, beryllium, or combinations thereof. In one embodiment, the alloy or the composite is completely free of nickel, aluminum, titanium, beryllium, or combinations thereof.

For example, the amorphous alloy can have the formula (Zr, Ti)a(Ni, Cu, Fe)b(Be, Al, Si, B)c, wherein a, b, and c each represents a weight or atomic percentage. In one embodiment, a is in the range of from 30 to 75, b is in the range of from 5 to 60, and c is in the range of from 0 to 50 in atomic percentages. Alternatively, the amorphous alloy can have the formula (Zr, Ti)a(Ni, Cu)b(Be)c, wherein a, b, and c each represents a weight or atomic percentage. In one embodiment, a is in the range of from 40 to 75, b is in the range of from 5 to 50, and c is in the range of from 5 to 50 in atomic percentages. The alloy can also have the formula (Zr, Ti)a(Ni, Cu)b(Be)c, wherein a, b, and c each represents a weight or atomic percentage. In one embodiment, a is in the range of from 45 to 65, b is in the range of from 7.5 to 35, and c is in the range of from 10 to 37.5 in atomic percentages. Alternatively, the alloy can have the formula (Zr)a(Nb, Ti)b(Ni, Cu)c(Al)d, wherein a, b, c, and d each represents a weight or atomic percentage. In one embodiment, a is in the range of from 45 to 65, b is in the range of from 0 to 10, c is in the range of from 20 to 40 and d is in the range of from 7.5 to 15 in atomic percentages. One exemplary embodiment of the aforedescribed alloy system is a Zr—Ti—Ni—Cu—Be based amorphous alloy under the trade name Vitreloy™, such as Vitreloy-1 and Vitreloy-101, as fabricated by Liquidmetal Technologies, CA, USA. Some examples of amorphous alloys of the different systems are provided in Table 1 and Table 2.

TABLE 1
Exemplary amorphous alloy compositions

| Alloy | Atm % | Atm % | Atm % | Atm % | Atm % | Atm % | Atm % | Atm % |
|---|---|---|---|---|---|---|---|---|
| 1 | Fe | Mo | Ni | Cr | P | C | B | |
| | 68.00% | 5.00% | 5.00% | 2.00% | 12.50% | 5.00% | 2.50% | |
| 2 | Fe | Mo | Ni | Cr | P | C | B | Si |
| | 68.00% | 5.00% | 5.00% | 2.00% | 11.00% | 5.00% | 2.50% | 1.50% |
| 3 | Pd | Cu | Co | P | | | | |
| | 44.48% | 32.35% | 4.05% | 19.11% | | | | |
| 4 | Pd | Ag | Si | P | | | | |
| | 77.50% | 6.00% | 9.00% | 7.50% | | | | |
| 5 | Pd | Ag | Si | P | Ge | | | |
| | 79.00% | 3.50% | 9.50% | 6.00% | 2.00% | | | |
| 5 | Pt | Cu | Ag | P | B | Si | | |
| | 74.70% | 1.50% | 0.30% | 18.0% | 4.00% | 1.50% | | |

TABLE 2
Additional Exemplary amorphous alloy compositions (atomic %)

| Alloy | Atm % | Atm % | Atm % | Atm % | Atm % | Atm % |
|---|---|---|---|---|---|---|
| 1 | Zr | Ti | Cu | Ni | Be | |
| | 41.20% | 13.80% | 12.50% | 10.00% | 22.50% | |
| 2 | Zr | Ti | Cu | Ni | Be | |
| | 44.00% | 11.00% | 10.00% | 10.00% | 25.00% | |
| 3 | Zr | Ti | Cu | Ni | Nb | Be |
| | 56.25% | 11.25% | 6.88% | 5.63% | 7.50% | 12.50% |
| 4 | Zr | Ti | Cu | Ni | Al | Be |
| | 64.75% | 5.60% | 14.90% | 11.15% | 2.60% | 1.00% |
| 5 | Zr | Ti | Cu | Ni | Al | |
| | 52.50% | 5.00% | 17.90% | 14.60% | 10.00% | |
| 6 | Zr | Nb | Cu | Ni | Al | |
| | 57.00% | 5.00% | 15.40% | 12.60% | 10.00% | |
| 7 | Zr | Cu | Ni | Al | | |
| | 50.75% | 36.23% | 4.03% | 9.00% | | |
| 8 | Zr | Ti | Cu | Ni | Be | |
| | 46.75% | 8.25% | 7.50% | 10.00% | 27.50% | |
| 9 | Zr | Ti | Ni | Be | | |
| | 21.67% | 43.33% | 7.50% | 27.50% | | |
| 10 | Zr | Ti | Cu | Be | | |
| | 35.00% | 30.00% | 7.50% | 27.50% | | |
| 11 | Zr | Ti | Co | Be | | |
| | 35.00% | 30.00% | 6.00% | 29.00% | | |
| 12 | Zr | Ti | Fe | Be | | |
| | 35.00% | 30.00% | 2.00% | 33.00% | | |
| 13 | Au | Ag | Pd | Cu | Si | |
| | 49.00% | 5.50% | 2.30% | 26.90% | 16.30% | |
| 14 | Au | Ag | Pd | Cu | Si | |
| | 50.90% | 3.00% | 2.30% | 27.80% | 16.00% | |
| 15 | Pt | Cu | Ni | P | | |
| | 57.50% | 14.70% | 5.30% | 22.50% | | |
| 16 | Zr | Ti | Nb | Cu | Be | |
| | 36.60% | 31.40% | 7.00% | 5.90% | 19.10% | |
| 17 | Zr | Ti | Nb | Cu | Be | |
| | 38.30% | 32.90% | 7.30% | 6.20% | 15.30% | |
| 18 | Zr | Ti | Nb | Cu | Be | |
| | 39.60% | 33.90% | 7.60% | 6.40% | 12.50% | |
| 19 | Cu | Ti | Zr | Ni | | |
| | 47.00% | 34.00% | 11.00% | 8.00% | | |
| 20 | Zr | Co | Al | | | |
| | 55.00% | 25.00% | 20.00% | | | |

Other exemplary ferrous metal-based alloys include compositions such as those disclosed in U.S. Patent Application Publication Nos. 2007/0079907 and 2008/0118387. These compositions include the Fe(Mn, Co, Ni, Cu) (C, Si, B, P, Al) system, wherein the Fe content is from 60 to 75 atomic percentage, the total of (Mn, Co, Ni, Cu) is in the range of from 5 to 25 atomic percentage, and the total of (C, Si, B, P, Al) is in the range of from 8 to 20 atomic percentage, as well as the exemplary composition Fe48Cr15Mo14Y2C15B6. They also include the alloy systems described by Fe—Cr—Mo—(Y,Ln)—C—B, Co—Cr—Mo-Ln-C—B, Fe—Mn—Cr—Mo—(Y,Ln)—C—B, (Fe, Cr, Co)-(Mo,Mn)—(C,B)—Y, Fe—(Co,Ni)—(Zr,Nb,Ta)-(Mo,W)—B, Fe—(Al,Ga)—(P,C,B,Si,Ge), Fe—(Co, Cr,Mo,Ga,Sb)—P—B—C, (Fe, Co)—B—Si—Nb alloys, and Fe—(Cr—Mo)—(C,B)—Tm, where Ln denotes a lanthanide element and Tm denotes a transition metal element. Furthermore, the amorphous alloy can also be one of the exemplary compositions Fe80P12.5C5B2.5, Fe80P11C5B2.5Si1.5, Fe74.5Mo5.5P12.5C5B2.5, Fe74.5Mo5.5P11C5B2.5Si1.5, Fe70Mo5Ni5P12.5C5B2.5, Fe70Mo5Ni5P11C5B2.5Si1.5, Fe68Mo5Ni5Cr2P12.5C5B2.5, and Fe68Mo5Ni5Cr2P11C5B2.5Si1.5, described in U.S. Patent Application Publication No. 2010/0300148.

The amorphous alloys can also be ferrous alloys, such as (Fe, Ni, Co) based alloys. Examples of such compositions are disclosed in U.S. Pat. Nos. 6,325,868; 5,288,344; 5,368,659; 5,618,359; and 5,735,975, Inoue et al., Appl. Phys. Lett., Volume 71, p 464 (1997), Shen et al., Mater. Trans., JIM, Volume 42, p 2136 (2001), and Japanese Patent Application No. 200126277 (Pub. No. 2001303218 A). One exemplary composition is Fe72Al5Ga2P11C6B4. Another example is Fe72Al7Zr10Mo5W2B15. Another iron-based alloy system that can be used in the coating herein is disclosed in U.S. Patent Application Publication No. 2010/0084052, wherein the amorphous metal contains, for example, manganese (1 to 3 atomic %), yttrium (0.1 to 10 atomic %), and silicon (0.3 to 3.1 atomic %) in the range of composition given in parentheses; and that contains the following elements in the specified range of composition given in parentheses: chromium (15 to 20 atomic %), molybdenum (2 to 15 atomic %), tungsten (1 to 3 atomic %), boron (5 to 16 atomic %), carbon (3 to 16 atomic %), and the balance iron.

The aforedescribed amorphous alloy systems can further include additional elements, such as additional transition metal elements, including Nb, Cr, V, and Co. The additional elements can be present at less than or equal to about 30 wt %, such as less than or equal to about 20 wt %, such as less than or equal to about 10 wt %, such as less than or equal to about 5 wt %. In one embodiment, the additional, optional element is at least one of cobalt, manganese, zirconium, tantalum, niobium, tungsten, yttrium, titanium, vanadium and hafnium to form carbides and further improve wear and corrosion resistance. Further optional elements may include phosphorous, germanium and arsenic, totaling up to about 2%, and preferably less than 1%, to reduce melting point. Otherwise incidental impurities should be less than about 2% and preferably 0.5%.

In some embodiments, a composition having an amorphous alloy can include a small amount of impurities. The impurity elements can be intentionally added to modify the properties of the composition, such as improving the mechanical properties (e.g., hardness, strength, fracture mechanism, etc.) and/or improving the corrosion resistance. Alternatively, the impurities can be present as inevitable, incidental impurities, such as those obtained as a byproduct of processing and manufacturing. The impurities can be less than or equal to about 10 wt %, such as about 5 wt %, such as about 2 wt %, such as about 1 wt %, such as about 0.5 wt %, such as about 0.1 wt %. In some embodiments, these percentages can be volume percentages instead of weight percentages. In one embodiment, the alloy sample/composition consists essentially of the amorphous alloy (with only a small incidental amount of impurities). In another embodiment, the composition includes the amorphous alloy (with no observable trace of impurities).

### Electronic Devices

The embodiments herein can be valuable in the fabrication of electronic devices using a BMG. An electronic device herein can refer to any electronic device known in the art. For example, it can be a telephone, such as a cell phone, and a land-line phone, or any communication device, such as a smart phone, including, for example an iPhone™, and an electronic email sending/receiving device. It can be a part of a display, such as a digital display, a TV monitor, an electronic-book reader, a portable web-browser (e.g., iPad™), and a computer monitor. It can also be an entertainment device, including a portable DVD player, conventional DVD player, Blue-Ray disk player, video game console, music player, such as a portable music player (e.g., iPod™), etc. It can also be a part of a device that provides control, such as controlling the streaming of images, videos, sounds (e.g., Apple TV™), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

### Embodiments

One embodiment provides a method of determining an unknown degree of crystallinity, the method including first obtaining a master curve representing a relationship between heat capacity and crystallinity for a bulk-solidifying amorphous alloy of a given chemical composition. The method also includes providing an alloy specimen having the given chemical composition and an unknown degree of crystallinity, and measuring the heat capacity of the specimen. The method concludes by determining the unknown degree of crystallinity by comparing the calculated heat capacity to the master curve.

An alternative embodiment provides a method of determining an unknown degree of crystallinity, the method including first obtaining a master curve representing a respective relationship between heat capacity and crystallinity for a bulk-solidifying amorphous alloy of a given chemical composition. The method also includes providing an alloy specimen having the given chemical composition and an unknown degree of crystallinity, and measuring the heat capacity of the specimen by heating the specimen, and then allowing the specimen to cool while continuously changing the environmental temperature, and taking an average of the heat capacity over a range of environmental temperatures. The method concludes by determining the unknown degree of crystallinity by comparing the heat capacity to the master curve.

Another embodiment provides a method of determining an unknown degree of crystallinity that includes first measuring the heat capacity of a bulk-solidifying amorphous alloy of a given chemical composition in its purely amorphous state and its purely crystalline state. The method also includes providing an alloy specimen having the given chemical composition and an unknown degree of crystallinity, and measuring the heat capacity of the specimen. The method concludes by determining the unknown degree of crystallinity by subtracting the heat capacity of the alloy specimen from the heat capacity of the purely amorphous alloy, and dividing that value by the difference between the heat capacities of the purely amorphous alloy and the purely crystalline alloy.

Another embodiment is an apparatus for non-destructively measuring the crystallinity in a bulk-solidifying amorphous alloy sample. The apparatus includes a measurement sector that includes a mechanism for applying heat to a sample, a device for placing the specimen in a controlled environment, a mechanism for maintaining or changing the environmental temperature of the environment, and a mechanism for measuring the surface temperature of the specimen over time and the surface temperature of the environment over time. The apparatus also includes a calculation sector in communication with the measurement sector, the calculation sector containing at least a storage device for storing and calculating the relationship between crystallinity and heat capacity for a given bulk-solidifying amorphous alloy, a mechanism to calculate the heat capacity of the sample based at least on the measured temperatures of the specimen and environment, and a mechanism to calculate the degree of crystallinity of the sample based on the calculated heat capacity.

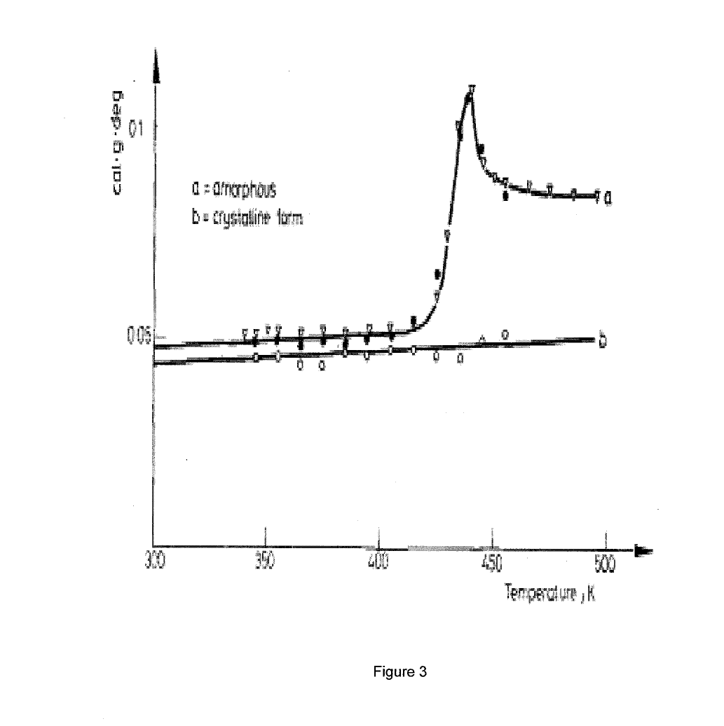

Embodiments make use of the difference in heat capacity between bulk-solidifying amorphous alloys having varying degrees of crystallinity. Bulk-solidifying amorphous alloys that are highly crystalline have a lower heat capacity, or specific heat than alloys of the same composition, but that are more amorphous. The heat capacity of any material also is dependent on the temperature at which the heat capacity is measured. FIG. 3 provides curves for the changes in heat capacity for an amorphous form of an alloy (a), and the crystalline form of an alloy (b). FIG. 3 shows the heat capacity variation for a eutectic germanium-tellurium alloy, and has been excerpted from Clechet, et al., “Thermodynamic and Thermokinetic Characterization of Vitreous Eutectic Germanium-Tellurium Alloy by Differential Scanning calorimetry,” J. Therm. Anal., Vol. 16, pp 59-71 (1979). The crystalline form (b) shows a somewhat linear relationship over the temperature range, whereas the amorphous form (a) shows a peak at about 480 K, where the amorphous sample begins to become partially crystallized.

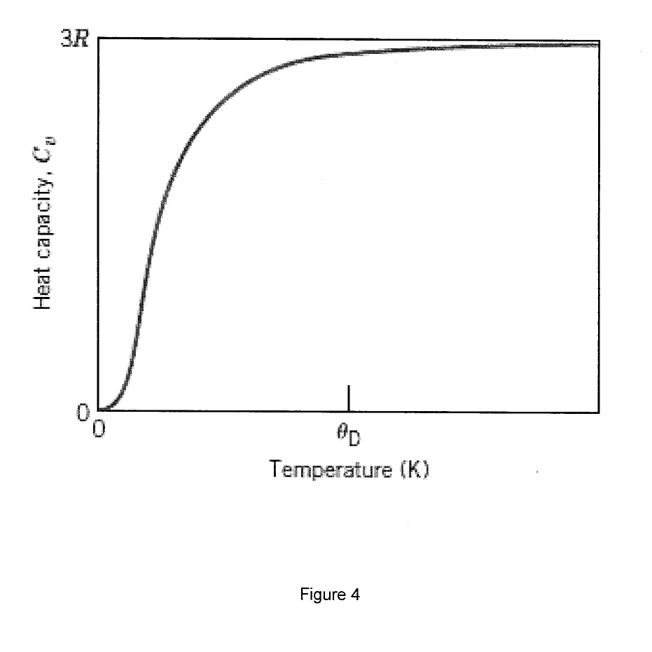

At lower temperatures, the relationship between heat capacity and temperature generally is not linear, but rather increases exponentially until it approaches the Debye temperature, which typically is about 3 times the universal gas constant R. This can be seen with reference to FIG. 4, which shows the heat capacity rising exponentially with increasing temperature until it generally levels off and asymptotically approaches 3R after reaching the Debye temperature θ_{D}. To compare the heat capacity of samples of materials of varying crystallinity, or varying chemical compositions, the comparison therefore should take place at a temperature above the Debye temperature. Otherwise the variability in the respective heat capacities could lead to an erroneous comparison.

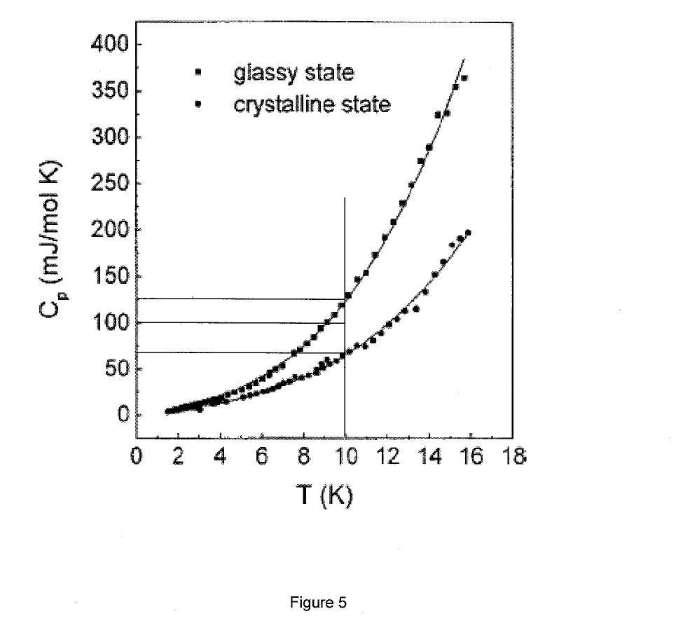

For bulk-solidifying amorphous alloys, the relationship between heat capacity and temperature varies similarly to that shown in FIG. 4. In the lower temperature range, e.g., at temperatures between 0 K and about 15 K, for example, the heat capacity increases exponentially, as shown in FIG. 5. FIG. 5 was excerpted from Bai, et al., Low Temperature Specific Heat of Bulk Glassy and Crystalline Zr₄₁Ti₁₄Cu_{12.5}Ni₁₀Be_{22.5} Alloys,” Applied Physics Letters, Vol. 78, pp. 2697-2699 (2001), and Bai, et al., “Low Temperature Specific Heat of a Typical Glass Forming Alloy,” J. App. Phys., Vol. 91, pp. 9123-9127 (2002). The relationship between heat capacity and temperature at this lower temperature range can be fitted to the equation (1):

Cp=γT+βT³ (1)

where T is the temperature, γ is a coefficient corresponding to the electronic contribution to heat capacitance, and β is a coefficient corresponding to the lattice contribution to heat capacitance. For the fully amorphous alloy, γ and β are 4.06 (mJ/mol K²) and 0.0833 (mJ/mol K⁴), respectively, whereas for the fully crystalline alloy, γ and β are 2.71 (mJ/mol K²) and 0.03846 (mJ/mol K⁴), respectively.

The crystallinity of a sample of unknown crystallinity can be determined from the graph shown in FIG. 5, if the heat capacity were determined at a low temperature, for example, within the range or slightly outside the range of FIG. 5. For example, given the values of γ and β for the fully amorphous (0% crystalline) and fully crystalline (100% crystalline), and assuming the values of γ and β are linear over the range of crystallinity, then the following equations can be established for each coefficient:

γ=−0.135x+4.06

β=−0.0449x+0.8333

where x is the crystallinity. If, for example, the heat capacity of a bulk amorphous alloy specimen having the same composition as the composition used to create the graph of FIG. 5 (Zr₄₁Ti₁₄Cu_{12.5}Ni₁₀Be_{22.5}) but with an unknown crystallinity was measured at 10 K, and the value obtained was 100 mJ/mol K, then the crystallinity of the specimen could be determined by substituting the equations for γ and β above into equation 1, to obtain the following:

100=10(−0.135x+4.06)+1,000(−0.0449x+0.833)

This equation can be solved for x to equal 0.5177, or 51.77% crystalline. Accordingly, the degree of crystallinity, and hence the amorphicity (1−% crystalline=0.4823 or 48.23%) of the sample can be determined by first obtaining a master graph of heat capacity as a function of temperature, obtaining the relationship between heat capacity and temperature, measuring the heat capacity of a specimen having the same chemical composition but unknown crystallinity at a given temperature, and determining the crystallinity of the sample.

The value obtained in the hypothetical above can be confirmed as a correct value by calculating the % crystallinity in accordance with the following equation, which is based on the known heat capacity for the fully amorphous, fully crystalline, and unknown crystallinity. Referring again to FIG. 5, if the heat capacity of the bulk-solidifying amorphous alloy sample of unknown crystallinity were measured at 10 K, and the value obtained was 100 mJ/mol K, then the crystallinity of the specimen could be determined by the following equation (2):

$$\% crystallinity = 1 - \frac{Cp ( a ) - Cp ( s )}{Cp ( a ) - Cp ( c )} \qquad ( 2 )$$

where Cp(a) is the heat capacity of the fully amorphous alloy; Cp(s) is the heat capacity of the measured sample; and Cp(c) is the heat capacity of the fully crystalline alloy. FIG. 5 includes lines drawn to show Cp(a) as about 130 mJ/mol K, Cp(s) was 100 mJ/mol K, and Cp(c) is about 68 mJ/mol K. Substituting these values into equation (2) provides a crystallinity of 51.6%. This value is well within experimental error and is the same as the value calculated above.

The embodiments described so far have only required a measurement of the heat capacity of samples of a known alloy composition for a fully amorphous and a fully crystalline sample. Samples can readily be prepared having 0% and 100% crystallinity respectively simply by melting the alloy composition and then either cooling it rapidly enough to avoid the crystallization region, as shown in FIG. 1 to provide 0% crystallinity, or by cooling it slowly to result in a fully crystalline alloy material. The heat capacity of each respective material then can be measured readily at various temperatures to provide curves of heat capacity versus temperature for the two samples, and then the crystallinity of an unknown sample can be determined by measuring its heat capacity at a given temperature, and then comparing that heat capacity to the curve, and the equations generated there from, to calculate the crystallinity.

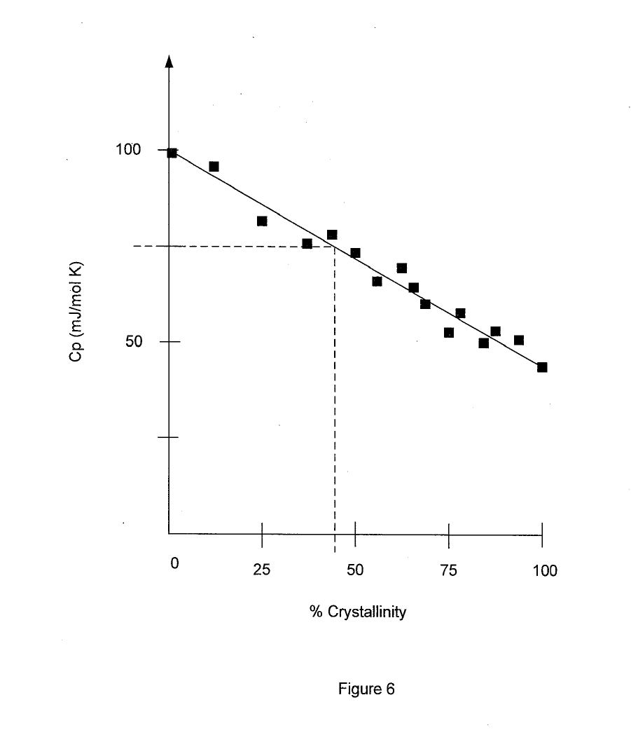

Another embodiment includes preparing a number of samples of a bulk solidifying amorphous alloy of a known chemical composition having varying degrees of crystallinity. The crystallinity can be varied by thermal annealing an amorphous alloy to above the crystallization temperature and then cooling the sample. The heat capacity of the samples then can be measured at a given temperature, and a master curve drawn showing the relationship between the crystallinity and the heat capacity. A representative curve is shown in FIG. 6, which as seen, is a linear relationship in which heat capacity constantly decreases as the crystallinity increases. A least squares fit or other known statistical technique can be used to determine the equation for the linear relationship between crystallinity and heat capacity at a given temperature. The equation for the line drawn in FIG. 6 could be:

Cp=−0.52x+100

where x is the crystallinity.

In this embodiment, a specimen having the same chemical formula as the alloy used to create the master curve in FIG. 6, but with an unknown crystallinity, then could have its heat capacity measured at the same temperature as that used in FIG. 6 (e.g., at about 284° C.), and the crystallinity determined using the equation generated from the master curve. If the heat capacity were measured at 284° C. to be, for example, about 75 mJ/mol K, then the crystallinity of the specimen would be about 48%, as shown by the dotted lines in FIG. 6.

Master curves could be generated for these samples having varying crystallinity at a variety of temperatures so that the heat capacity can be measured at those various temperatures, thus providing a degree of variability. In addition, the heat capacity of the specimen of unknown crystallinity could be determined at different temperatures and the values obtained compared for accuracy, and averaged if needed to provide a more accurate value for the crystallinity of the specimen. Moreover, the heat capacity could be determined using a variety of different environmental temperatures, (e.g., by pulsing the external temperature in a sinusoidal fashion, or simply raising the temperature, lowering the temperature, or both), even though the specimen temperature remained the same (hence, AT would change because Te would vary, even if Ts stayed the same), and the value averaged over the temperature intervals. Using the averaged heat capacity, the crystallinity then could be determined using any of the techniques described above.

### Heat Capacity Determination

Heat capacity generally is referred to as the amount of heat required to change a substance's temperature by a given amount. The molar heat capacity (the values in the graphs of FIGS. 5 and 6 are molar heat capacities) is the heat capacity per mole of substance, regardless of the mass, whereas the specific heat capacity is the heat capacity per unit mass of a material. While FIGS. 5 and 6 presented data in terms of molar heat capacity, the same relationship exists between specific heat capacity and temperature, and specific heat capacity and degree of crystallization. The specific heat capacity can be determined by measuring the amount of heat (Q) generated of emitted from the sample, at a given temperature, and a known external or environmental temperature, using the following equation (3):

Q=mCpΔT

where Q is the amount of heat, m is the mass of the specimen, and ΔT is the temperature differential between the specimen temperature and the environmental or external temperature (or the temperature of the specimen at equilibrium, and the initial temperature).

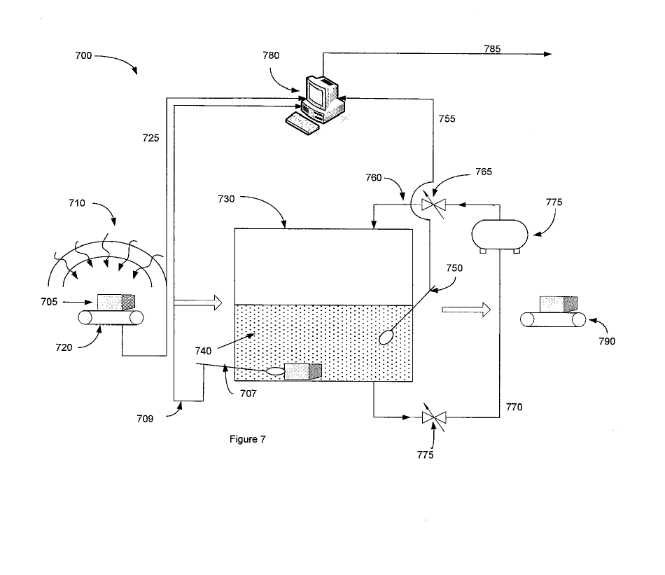

The value of Q can be determined using a calorimeter. Many different types of calorimeters can be used in the embodiments, including isothermal microcalorimeters, differential scanning calorimeters, accelerated rate calorimeters, or a very simple calorimeter that includes a container full of water into which a sample can be placed. Some of these calorimeters may require a sample size that could require destruction of the bulk-solidifying amorphous alloy. An apparatus that can be used to measure the heat capacity of a sample of a bulk-solidifying amorphous alloy is shown in FIG. 7. While the apparatus shown in FIG. 7 can be used to determine the heat capacity of a material having a given mass, other apparatus can be used in the embodiments. Indeed, any apparatus capable of determining the heat capacity of a material can be used in the embodiments.

FIG. 7 illustrates an apparatus 700 that can be used not only to determine the heat capacity of a bulk-solidifying amorphous alloy specimen 705, but also can be used in a process control system used to control the manufacture of bulk-solidifying amorphous alloy materials. While not necessary, in one embodiment, the same apparatus 700 can be used to determine the heat capacity of a bulk-solidifying amorphous alloy having an unknown crystallinity, as the apparatus used to create the master curve, and/or to determine the heat capacity of a fully amorphous and fully crystalline sample. In this embodiment, any fluctuations in actual heat capacity due to heat loss in insulated heat capacity measurement device 730 would be the same or similar to the fluctuations for all measurements. It is not necessary that the actual heat capacity of the bulk-amorphous specimen, and test samples (e.g., those used to create a master curve, and those that are fully amorphous and fully crystalline), but rather that the relationship between the respective heat capacities be accurately determined so that the crystallinity of the specimen can be accurately determined. Accordingly, even if insulated heat capacity measurement device 730 were to determine a heat capacity that is, say 15-50% higher than that determined using a more accurate and expensive device (e.g., and DSC or other calorimeter), the crystallinity still will be accurately determined by the apparatus 700 since all of the heat capacities will be 15-50% higher.

Specimen 705 of unknown crystallinity may be diverted during manufacture from the production line for quality control testing, or each sample may be tested using the embodiments described herein. Prior to determining the heat capacity, however, specimen 705 can be heated to a certain temperature, preferably below its glass transition temperature by subjecting specimen 705 to radiation at heating mechanism 710, which may be in the form of a convection heater, a heated jacket, a laser, a hemispherical irradiation dome, or any mechanism capable of heating a solid sample. The mass of specimen 705 also can be determined using a conveyor 720 having a scale positioned thereon so that the mass of specimen 705 can be accurately determined. The scale on conveyor 720 can be connected via communication link 725 to a storage and computational device 780 for recording and storing the mass measured by conveyor 720. Communication link 725 may be a wireless connection, connection via a local area network or other network, or may be directly connected to storage and computational device 780.

Storage and computational device 780 can be any device capable of storing information and processing that information and performing calculations to determine the heat capacity. Suitable storage and computational devices 780 include, for example, personal computers, main frame computers, personal data assistants, smart phones, hand-held devices such as an iPad, and the like. Storage and computational device 780 may be a stand-alone device, or may be connected via a network or direct connection 785 to a process control system. Storage and computational device 780 also is in communication with temperature sensor 707 via communication link 709 for recording and storing the temperature of specimen 705 over time as it is placed in insulated heat capacity measurement device 730. Storage and computational device 780 further is in communication with temperature sensor 750 via communication link 755 for recording and storing the temperature of fluid 740 over time as it exchanges heat with heated specimen 705.

Fluid 740 can be any fluid having a known heat capacity, or its heat capacity can be measured using insulated heat capacity measurement device 730 at various temperatures by virtue of exchanging heat with surrounding air in device 730. Fluid 740 may fill device 730 entirely, or may only partially fill the device. Fluid 740 can be water, alcohol, gel, air, gas, or any fluid capable of exchanging heat with specimen 705. The mass of fluid 740 can be readily determined by its density and knowing the volume of fluid 740 introduced to device 730 via line 760, as controlled by valve 765. The mass of fluid 740 should be the same for each measurement, and the value stored in storage and computational device 780, although it could vary for each batch, and the value measured and communicated to storage and computational device 780. After the heat capacity of specimen 705 is determined, fluid 740 can be withdrawn from device 730 (or it may remain in device 730 and cooled or heated as the case may be, to its original temperature) via line 770, controlled by valve 777. Fluid 740 may be stored in tank 775 where its temperature can be brought back to its original temperature when provided to device 730, or it may be discarded, as may be the case with water. Fresh water may be introduced to device 730 in this instance via line 760, in which the fresh water is maintained at a constant temperature. The original temperature of fluid 730 need not remain constant and may vary, and the value of that temperature recorded by temperature sensor 750 and conveyed to storage and computational device 780 prior to introduction of heated sample 705 to device 730. Once the heat capacity is determined by storage and computational device 780, specimen 705 can be removed from device 730 and transported via conveyor 790 to packaging, or recycle if found to be defective.

The heat capacity of specimen 705 can be determined by assuming that all of the heat lost by heated specimen 705 in insulated heat capacity measurement device 730 is gained by fluid 740. As stated above, even if some heat lost by heated specimen 705 is absorbed by the air or the walls of device 730, that lost heat only impacts the accuracy of the true value of the heat capacity of the specimen 705. The embodiments described herein do not require an exact and true value of the heat capacity of the specimen 705, but rather only require an accurate relationship between heat capacity of the specimen and the heat capacities of the test samples used to generate the master curve or of the purely amorphous and purely crystalline alloys. Thus, the system will accurately determine the crystallinity of the specimen 705 if the heat capacities of the test samples are measured using the same device that measures the heat capacity of the specimen. This process can be used for a variety of heat capacity measurement devices 730, which can be calibrated from time to time, and the values stored in storage and computational device 780 updated for each calibration.

Assuming that all heat lost by specimen 705 is gained by fluid 740, then the following equations can be used to determine the heat capacity of the specimen 705:

Q(fluid)=Q(specimen)

m(f)Cp(f)[T₂(f)−T₁(f)]=m(s)Cp(s)[T₁(s)−T₂(s)] (3)

where (f) denotes fluid and (s) denotes sample; m is mass; Cp is heat capacity, and T₁ and T₂ are initial and final temperatures, respectively.

The following variables are either known or measurable using the apparatus 700:
m(f)—control valve 765 determines mass—may be predetermined or varied and recorded value communicated to device 780;
Cp (f)—predetermined—either measured prior to use, or use of known fluid, e.g., water with Cp of 4.188 J/g K at 15° C.;
T₁(f)—measured at 750 prior to introduction of heated specimen 705;
T₂(f)—measured at 750 over time or after equilibrium temperature is reached, in which case T₂(f)=T₂(s);
m(s)—measured at 720 and communicated to device 780;
T₁(s)—measured at 707 and communicated to device 780;
T₂(s)—measured at 707 over time or after equilibrium is reached, in which case T₂(f)=T₂(s).
   Thus, the only unknown in equation (3) above is Cp(s), which can be determined by the following equation (f):

$$Cp ( s ) = \frac{m ( f ) Cp ( f ) [ T 2 ( f ) - T 1 ( f ) ]}{m ( s ) [ T 1 ( s ) - T 2 ( s ) ]}$$

Storage and computational device 780 can be programmed to calculate the heat capacity of the specimen using the above equation. Storage and computational device 780 also can be programmed to calculate the crystallinity of specimen 705 using any of the methods described above. Storage and computational device 780 can be in communication with any known calorimeter (other than apparatus 700) that can be used for measuring heat capacity of a sample using techniques known in the art, and also can be use programmed using the guidelines provided herein to determine the crystallinity of specimen 705. Thus, devices 710, 720, and 730 with their attendant connections can be considered a measurement sector, and storage and computational device 780 can be considered a calculation sector.

The heat capacity can be calculated after the temperature of fluid 740 is equilibrated, or it may be calculated periodically, say every minute, using the temperatures from temperature sensors 707 and 750, respectively. Thus, an average heat capacity for specimen 705 may be obtained. In addition, the temperature of fluid 740 can be varied by subjecting device 730 to periodic heating or cooling, the respective temperatures measured at 707 and 750, and the heat capacities at a variety of temperatures recorded and stored in device 780. The average heat capacity at a given temperature then can be compared to the heat capacities of the purely amorphous and purely crystalline sample at that same given temperature to determine the crystallinity, either using a master curve as shown in FIG. 6, or using equation (3) above.

Storage and computational device 780 may have stored therein a variety of master curves for a variety of bulk-solidifying amorphous alloy samples having different chemical compositions, as well as a plurality of heat capacity measurements (as well as other physical properties such as electrical resistivity, thermal emissivity, etc.) for fully amorphous and fully crystalline alloys for a variety of bulk-solidifying amorphous alloys having different chemical composition. Thus, different master curves and equations can be used depending on the particular chemical composition of the alloy being produced.

Depending on the application, a bulk-solidifying amorphous alloy having any crystallinity can be undesirable, or it may be desirable to produce a bulk-solidifying amorphous alloy having a certain degree of crystallinity (e.g., above 15%). On the other hand, it is equally undesirable to destroy the bulk-solidifying amorphous alloy part in order to measure its crystallinity. Thus, it is desirable to monitor and/or measure the degree of crystallinity of an amorphous alloy sample non-destructively. The aforedescribed methods involving using a master curve plot can be useful.

The presently described methods can provide a non-destructive way of monitoring and/or measuring the quality of an alloy product particularly in an alloy fabrication process in terms of the degree of crystallinity. For example, an additional monitoring step can be added. In one embodiment, criteria of qualities to be considered as “good” and “bad” can be introduced such that a binary determination of “good” and “bad” product can be added after the determination of the degree of crystallinity. Such binary indicators can be used to accept or reject a product. This quality measurement/determination can also be used to evaluate the process of making the alloy, as shown below, thereby allowing modification and/or optimization of the fabrication process.

An apparatus that can carry out the aforedescribed methods can be employed as a quality control apparatus, which can be integrated with the metallic glass fabrication system via communication link 785. For example, if the indicator in the apparatus shows a “bad” signal, the apparatus can send a signal to the fabrication system to stop the process. Alternatively, the signal can be sent to the fabrication system to modify the fabrication conditions (e.g., temperature, pressure, etc.) to optimize the quality of the product. The quality control feedback of the system integrated with the apparatus can be continuous—i.e., the feedback is continuously sent and received by the fabrication system and adjustments are made continuously. Alternatively, the feedback can be discrete—i.e., the signal is sent at a specified time and the fabrication system can be monitored and examined then based on the feedback.

Furthermore, instead of a binary “good” or “bad” determination, the presently described methods can be used to describe directly the levels/degrees of crystallinity. In one embodiment, such post-processing/fabricating determination can provide feedback in the fabrication process such that the fabrication parameters can be adjusted to optimize the product quality. In one embodiment, the entire process that includes fabrication, quality monitoring, and parameter adjustment can be automated, i.e., controlled by computer.

The aforedescribed quality control can be valuable in the fabrication process involving using BMG. Because of the superior properties of BMG, BMG can be made into structural components in a variety of devices and parts. One such type of device is an electronic device.

An electronic device herein can refer to any electronic device known in the art. For example, it can be a telephone, such as a cell phone, and a land-line phone, or any communication device, such as a smart phone, including, for example an iPhone™, and an electronic email sending/receiving device. It can be a part of a display, such as a digital display, a TV monitor, an electronic-book reader, a portable web-browser (e.g., iPad™), and a computer monitor. It can also be an entertainment device, including a portable DVD player, conventional DVD player, Blue-Ray disk player, video game console, music player, such as a portable music player (e.g., iPod™), etc. It can also be a part of a device that provides control, such as controlling the streaming of images, videos, sounds (e.g., Apple TV™), or it can be a remote control for an electronic device. It can be a part of a computer or its accessories, such as the hard drive tower housing or casing, laptop housing, laptop keyboard, laptop track pad, desktop keyboard, mouse, and speaker. The article can also be applied to a device such as a watch or a clock.

The articles “a” and “an” are used herein to refer to one or to more than one (i.e., to at least one) of the grammatical object of the article. By way of example, “a polymer resin” means one polymer resin or more than one polymer resin. Any ranges cited herein are inclusive. The terms “substantially” and “about” used throughout this Specification are used to describe and account for small fluctuations. For example, they can refer to less than or equal to ±5%, such as less than or equal to ±2%, such as less than or equal to ±1%, such as less than or equal to ±0.5%, such as less than or equal to ±0.2%, such as less than or equal to 0.1%, such as less than or equal to ±0.05%.

What is claimed:

1. A method of determining an unknown degree of crystallinity for a bulk-solidifying amorphous alloy, comprising:
obtaining a master curve representing a relationship between heat capacity and crystallinity for a bulk-solidifying amorphous alloy having a given chemical composition;
providing a bulk-solidifying amorphous alloy specimen having the given chemical composition and an unknown degree of crystallinity;
measuring the heat capacity of the specimen; and
determining the unknown degree of crystallinity by comparing the measured heat capacity to the master curve.

2. The method of claim 1, wherein obtaining a master curve comprises preparing a plurality of bulk-solidifying amorphous alloy samples having the same chemical composition but varying crystallinity, measuring the heat capacity of each sample at the same temperature, and plotting the heat capacity against the crystallinity.

3. The method of claim 1, wherein measuring the heat capacity of the specimen is conducted at the same temperature as the temperature used to measure the heat capacities used to construct the master curve.

4. The method of claim 1, wherein determining the unknown degree of crystallinity comprises generating an equation from the master curve that represents the relationship between heat capacity and crystallinity, and calculating the crystallinity of the specimen using the equation.

5. The method of claim 4, wherein the equation is a linear equation.

6. The method of claim 2, wherein at least two samples are prepared, wherein at least one sample is fully amorphous and at least one sample is fully crystalline.

7. A method of determining an unknown degree of crystallinity for a bulk-solidifying amorphous alloy, comprising:
obtaining a master curve representing a relationship between heat capacity and crystallinity for a bulk-solidifying amorphous alloy of a given chemical composition;
providing an alloy specimen having the given chemical composition and an unknown degree of crystallinity;
measuring the heat capacity of the specimen by heating the specimen, and then allowing the specimen to cool while continuously changing the environmental temperature, and taking an average of the heat capacity over a range of environmental temperatures; and
determining the unknown degree of crystallinity by comparing the heat capacity to the master curve.

8. The method of claim 7, wherein measuring the heat capacity comprises monitoring the temperature of the specimen and the environment; providing an environment with a known heat capacity and mass; measuring the mass of the specimen, and determining the heat capacity of the specimen over a variety of temperatures using the following equation:
$$Cp ( s ) = \frac{m ( f ) Cp ( f ) [ T 2 ( f ) - T 1 ( f ) ]}{m ( s ) [ T 1 ( s ) - T 2 ( s ) ]}$$
where (f) denotes environment and (s) denotes specimen; m is mass; Cp is heat capacity, and T₁ and T₂ are initial and final temperatures, respectively of the environment and specimen.

9. The method of claim 7, wherein measuring the heat capacity of the specimen is conducted at the same temperature as the temperature used to measure the heat capacities used to construct the master curve.

10. The method of claim 7, wherein determining the unknown degree of crystallinity comprises generating an equation from the master curve that represents the relationship between heat capacity and crystallinity, and calculating the crystallinity of the specimen using the equation.

11. The method of claim 10, wherein the equation is a linear equation.

12. The method of claim 7, wherein obtaining a master curve comprises preparing a plurality of bulk-solidifying amorphous alloy samples having the same chemical composition but varying crystallinity, measuring the heat capacity of each sample at the same temperature, and plotting the heat capacity against the crystallinity.

13. The method of claim 12, wherein at least two samples are prepared, wherein at least one sample is fully amorphous and at least one sample is fully crystalline.

14. A method of determining an unknown degree of crystallinity for a bulk-solidifying amorphous alloy, comprising:
determining the heat capacity of a bulk-solidifying amorphous alloy of a given chemical composition in its purely amorphous state and its purely crystalline state at a given temperature;
providing an alloy specimen having the given chemical composition and an unknown degree of crystallinity;
determining the heat capacity of the specimen at the given temperature; and
determining the unknown degree of crystallinity by subtracting the heat capacity of the alloy specimen from the heat capacity of the purely amorphous alloy, and dividing that value by the difference between the heat capacities of the purely amorphous alloy and the purely crystalline alloy.

15. An apparatus for non-destructively measuring the crystallinity of a bulk-solidifying amorphous alloy specimen, comprising:
(a) a measurement sector that comprises:
(1) a mechanism for applying heat to a specimen;
(2) a device for placing the specimen in a controlled environment;
(3) a mechanism for maintaining or changing the environmental temperature of the environment; and
(4) a mechanism for measuring the surface temperature of the specimen over time, and a mechanism for measuring the surface temperature of the environment over time; and
(b) a calculation sector in communication with the measurement sector, the calculation sector comprising:
(1) a storage device for storing and calculating the relationship between crystallinity and heat capacity for a given bulk-solidifying amorphous alloy;
(2) a mechanism for calculating the heat capacity of the specimen based at least on the measured temperatures of the specimen and environment; and
(3) a mechanism for calculating the crystallinity of the specimen based on the calculated heat capacity.

16. The apparatus of claim 15, wherein the measurement sector also includes a mechanism for measuring the mass of the specimen.

17. The apparatus of claim 16, wherein the environment is a fluid having a known heat capacity and a known mass.

18. The apparatus as claimed in claim 17, wherein the mechanism for calculating the heat capacity is a computer storable medium capable of calculating the heat capacity using the following equation:
$$Cp ( s ) = \frac{m ( f ) Cp ( f ) [ T 2 ( f ) - T 1 ( f ) ]}{m ( s ) [ T 1 ( s ) - T 2 ( s ) ]}$$
where (f) denotes environment and (s) denotes specimen; m is mass; Cp is heat capacity, and T₁ and T₂ are initial and final temperatures, respectively of the environment and specimen.

19. The apparatus of claim 15, further comprising a process control sector in communication with the calculation sector, wherein the process control sector controls a process for making the bulk-solidifying amorphous alloy specimen, and the calculation sector communicates feedback to the process control sector depending on the calculated crystallinity.

20. The apparatus of claim 15, wherein the calculation sector is a storage and computational device.
